(19) United States
(12) Patent Application Publication
(10) Pub. No.: US 2026/0234808 A1
(43) Pub. Date: Aug. 13, 2026

(54) Rapid Solution Combustion Synthesis of Highly Ordered Porous Metal Oxide Layers

(71) Applicant: The Board of Trustees of the Leland Stanford Junior University, Stanford, CA (US)

(72) Inventors: Thomas Colburn, Redwood City, CA (US); David W. Collinson, Auckland (NZ); Reinhold H. Dauskardt, Menlo Park, CA (US); Robert D. Miller, San Jose, CA (US)

(21) Appl. No.: 19/470,995

(22) PCT Filed: Apr. 3, 2024
(86) PCT No.: PCT/US2024/022868

§ 371 Date: Sep. 30, 2025

Related U.S. Application Data
(60) Provisional application No. 63/456,701, filed on Apr. 3, 2023.

(51) Int. Cl. C23C 26/00; C01F 7/30; C09D 1/00

(52) U.S. Cl. CPC C23C 26/00; C01F 7/30; C09D 1/00

(57) ABSTRACT

Fabrication of highly ordered metal oxide layers is performed by combining deposition of an oxidant-containing precursor, a pore-generating precursor, and a metal-containing precursor, depositing the precursor, and combustion of the precursor to form a metal oxide layer. In one example, high-quality porous aluminum oxide layers with controlled, 7 nm ordered porosity is demonstrated.

### FIELD OF THE INVENTION

This invention relates to fabrication of metal oxide layers.

### BACKGROUND

Highly ordered, mesoporous thin film oxides are a sought-after class of materials due to their high surface area, functionalizable pore walls, and controllable pore volume. Mesoporous oxides have been used for optoelectronics, sensing, dielectrics, batteries, and catalysis. The ability to fill the metal oxide porosity with various polymers, small molecules, or use the oxide as an etchable template has given rise to unique and tunable nanostructures.

In particular, extensive research has been performed on leveraging sol-gel processes to develop mesoporosity in thin films of silica and alumina. These research efforts have also focused on control of the rates of hydrolysis and condensation to affect film structure and the modification of the porogen to affect the oxide film properties. Intrinsic limitations of throughput, cost, and precursor stability, however, have greatly limited their manufacturing potential via sol-gel.

The typical fabrication process for porous, thin film oxides involves a multi-step formation process where the sol is first aged in the presence of an acid or base at very high or low PH along with a polymeric porogen to form sol particles which are deposited via a solution method like spin coating.

The porogen polymers form micelles based on their hydrophilic and hydrophobic moieties in the drying film driven by evaporation-induced self-assembly (EISA). During the assembly process, the highly polar metal sol precursor containing metal hydroxide groups affiliates to the hydrophilic corona of the micelle leaving the hydrophobic core free of metal species.

The films are then slowly dried under controlled relative humidity and temperature to drive further hydrolysis and subsequential condensation processes. High temperatures at incremental ramp rates are used to drive condensation to competition, metal oxide network densification, and porogen removal.

Because of the use of a sol-gel process, however, the current state-of-the-art mesoporous thin film methods struggle from a number of critical drawbacks which predominately affect manufacturability. Firstly, the precursor sol and films during aging are highly sensitive to temperature, relative humidity, and pH. As a result, the successful deposition demands exacting control of solution fabrication and aging steps during which hydrolysis and condensation progress. These aging steps can last approximately four hours with dependency on the hydrolysis rate of the metal cation and be sensitive to small perturbations in humidity of +10% RH. Secondly, the metal alkoxides that are often used in sol-gel methods are expensive relative to their inorganic salt counterparts and highly prone to degradation and hydrolysis over time. Thirdly, the high temperatures used to densify the oxide and burn out the porogen makes for highly energy-intensive processes lasting often upwards of 12 hrs. Finally, the processing conditions together typically demand upwards of three days of processing time when combining the controlled aging steps and slow thermal ramps to high curing temperatures. As such, the combination of low-throughput, high energy, and high environmental sensitivity make mass production of mesoporous metal oxide thin films prohibitively difficult for implementation at a larger scales and lower costs.

Accordingly, it would advance the state of the art to develop new methods of generating layers of ordered porous metal oxides.

### SUMMARY

Solution combustion synthesis (SCS) is a next-generation method of generating metal oxide powders at substantially reduced process temperatures (often <300° C.) and with the potential to use green, affordable precursors. The metal oxide is typically produced from a mixture of a metal nitrate, which acts as both the metal source and oxidant, and an organic fuel which is also a chelator to the metal species. Ideally, the organic chelating fuel acts to both inhibit premature hydrolysis and gelation of the solution as well as to participate in the exothermic redox reaction that results in the desired metal oxide. The combustion reaction has a significantly higher reaction enthalpy than sol-gel processes and generates substantial heat allowing the reaction to be self-sustaining.

Due to the need to generate a manufacturable method for producing large areas of thin film mesoporous oxides (here and throughout this work, “thin film”, “layer” and “coating” are regarded as synonyms) at reduced fabrication costs, with less demanding process controls, and with higher throughputs, we consider in detail below an example where a combination of EISA to form mesoporosity with SCS generates the metal oxide in a highly rapid, low-cost process.

In the process described, a metal source, oxidant, pore generating molecule, and organic chelating agent are combined to generate ordered nanoporous layers. When deposited, the solvent is evaporated from the film during which the pore generating molecules self-assemble into micelles with the metal species and oxidant affiliating into the outer hydrophilic moiety of the micelle. After assembly, the films are dried of their solvent and heated to above the ignition temperature at which point the rapid oxidation process between the oxidant, pore-generating molecule, and complexing agent occurs.

In some examples of this work, we have developed an approach utilizing solution combustion oxidation to produce highly ordered, porous (0.1-100 nm), metal oxide thin films rapidly from low-cost, available metal salts, complexing reagents, and an amphiphilic polymer that self assembles to micelles and often forms complexes with the added metal salts. The polymer serves both as a templating species for structure formation in the film and as a fuel source for the exothermic reaction. Here we term this process Porogen Integrated Rapid Oxidation (PIRO). The structure in the film is produced via evaporation induced self-assembly upon casting.

The initial step in this exemplary process involves making a solution in either a polar hydrogen bonding or dipolar aprotic solvent (e.g., ethanol, 2-methoxyethanol, water, dimethoxyethane, 1-butanol, etc.). The solution includes a metal salt, a porogen, a polar chelating molecule which also serves as a fuel for combustion, a pH-regulating base and a nonvolatile oxidant. The preferred embodiment is a metal nitrate salt (e.g., nickel nitrate, aluminum nitrate, zinc nitrate, etc.) which can serve as both the metal oxide source and the nonvolatile oxidant. For metals that do not form stable nitrates (e.g., tin), an external oxidant such as ammonium nitrate, nitric acid, perchlorate salts, etc. can be added. The chelating species can be metal complexing reagents such as acetylacetone, citric acid, malic acid, hydroxyglutaric acid, tartaric acid, etc.

Multiple metal precursors can be used simultaneously to produce a mixed metal oxide film. Additionally, other nonvolatile oxidants such as perchlorates, peroxydisulfates, peroxides, superoxides, and permanganates can be used as the oxidant source. Some specific examples of the porous films that can result from the outlined method are described below.

In these examples, diglyme, glycolic acid, diglycolic acid, or malic acid was added to a solution of metal nitrate in anhydrous ethanol, followed by the addition of aqueous ammonia to adjust the pH and drive complexation. The solution is then stirred for 1 hour before the amphiphilic polymer porogen (e.g., Pluronic® F127) is added. This solution is allowed to stir for 1-2 hours before deposition via spin coating. After deposition, the films are first aged under ambient conditions for 10-60 min to promote self-assembly and subsequently heated in an oven at a temperature above room temperature but below the ignition temperature (T_{ignition}) to remove solvent for an additional 10-60 min. The final curing, which results in the oxidative reaction, occurs at T≥T_{ignition} on a hotplate in air. Heating the film above the sample ignition temperature simultaneously results in both the formation and consolidation of the metal oxide network and removal of the polymer structuring agent. The resulting porous metal oxide films prepared as described are ready for incorporation into devices for applications.

The use of a metal complexing porogen provides multiple beneficial effects. This polymer serves as a structuring agent resulting in a highly ordered porous network, can (optionally) serve as a potential chelation agent to complex with metal ions prior to rapid oxidation, and finally can provide a fuel source to promote the rapid oxidation. The exothermic oxidation reaction occurs after deposition/structuring of the film and results in both the formation of the metal oxide and the removal of the porogen structuring agent in a single step. The rapid oxidation step delivers a key processing advantage over other competing technologies by decreasing processing temperature and time. The polymer used in these examples produces pore sizes on the order of 5 -15 nm depending on the oxide composition. While these pores have typical sizes for the described process, these can be varied by changes in porogen structure and molecular weight. In addition, the choice of solvent and processing conditions can also be modified to influence the pore structure and size. We expect that control of the porogen species allows for access to pores that range in size from 0.5-100 nm. Further, although the thin films of these examples have thicknesses on the order of 200-500 nm, tuning the deposition process and solution concentrations can produce films with thicknesses ranging from <10 nm to a few microns.

For the structuring agent, we have chosen non-ionic amphiphilic materials ideally, but not exclusively, including block copolymers containing hydrophobic and hydrophilic segments. A key feature for the ideal porogen is a hydrophilic segment that has chemical units capable of interacting with the metal cations (e.g., polyethers such as polyethylene oxide, poly-acrylic acids, hydroxyethyl methacrylates, acrylamides, etc.). Examples of commercial amphiphilic non-ionic surfactants that can be used include Pluronic® (BASF) and Brij surfactants, Dowfax nonionic surfactants, etc. Another important component is the polyfunctional chelator (e.g., diglycolic acid or malic acid) that is included in sufficient concentration to stabilize the solution and inhibit premature hydrolysis and hydroxide/oxide precipitation. After the solution is deposited as a thin film, the polyfunctional chelator also mediates the subsequent hydrolysis and condensation of the metal salt such that the self-assembly of film structure can occur. Additionally, the chelating agent also acts as a secondary fuel source. The final component of the solution is the base, which is included to adjust the pH of the solution to drive complexation of the metal ions with the carboxylic acid and the polymer structuring agent. Although we have observed rapid oxidation (from thermal analysis) in samples not containing any added base, the adjustment of pH usually leads to a more generally reproducible process.

The solution can be deposited on substrates using a variety of techniques, with specific examples including spin coating, blade coating, and ultrasonic spray deposition resulting in films that are typically 100s of nm thick. We also anticipate other deposition methods such as dip coating, meniscus coating, slot-die coating, etc. to be viable deposition approaches.

Advantages over sol-gel methods to generate ordered nanoporosity: Sol-gel processing generally requires fine-tuned control over environmental parameters (e.g., humidity), expensive alkoxide precursors, long aging times, and energy-intensive, multi-hour annealing steps to generate ordered porosity via EISA. Large area devices are difficult to achieve due to the need to maintain the environmental conditions across the processing area. Our preferred embodiment of ordered porous layers of aluminum oxide can be generated with as little as 1 minute of drying, 1 minute of aging, and 1 minute of flash annealing using a near-infrared curing system. Additionally, our preferred embodiment uses inexpensive nitrates and small molecule co-fuel complexing agents.

Advantages over nanoparticle sintering strategies: Porous films can be generated via nanoparticle sintering to yield interconnected porosity in the void space of the sintered particles. This method, however, requires high temperatures and often long annealing times to drive sintering processes rendering it incompatible with many flexible substrates. The oxide generated by this method is often disorganized and lacks the ordered structure observed in our preferred embodiment. In this alumina layer example, the thin films are generated at temperatures <250° C. in as little as 1 minute. Compatibility with flexible substrates including on polyimide is demonstrated. Furthermore, X-ray scattering demonstrates ordering of the porosity generated via the preferred embodiment through the bulk. The degree of ordering can be further controlled by the chemical identity of the organic ligand added in solution.

Due to the low temperatures required for formation of the porous oxide matrix, the flexibility in the composition of the metal oxide materials, and the ability to control the pore sizes and architectures, we see this technology having the potential to impact many commercial applications. We expect that chemical, optical, photonic, electrical, and biological fields can benefit from availability of highly ordered, scalable porous films for applications such as gas/liquid sensors (e.g., detection of toxins/pathogens, gas mixture analysis, including sensors/biosensors utilizing size selection, catalysis (e.g., transformation of CO₂, etc.), optoelectronics (e.g., up/down conversion material scaffolds and solar cell hole/electron transport layers), anti-reflective coatings, graded index photonics, dielectric materials both filled and unfilled, (e.g., capacitors or low-k dielectrics, ionic supercapacitors), semipermeable membranes, thermal barrier layers, drug delivery, etc.

### BRIEF DESCRIPTION OF THE DRAWINGS

FIGS. 1A-C schematically show an exemplary embodiment of the invention.

FIGS. 2A-D show combustion characterization experimental results.

FIGS. 3A-D show characterization results on the effect of adding ammonia.

FIGS. 3E-G are SEM images relating to the effect of adding ammonia.

FIGS. 4A-H are small angle x-ray diffraction and SEM results showing the effect of various small-molecule species on the order of the porosity in the porous metal oxide layers.

FIG. 5A schematically shows spray deposition.

FIG. 5B is an optical image of a spray deposited layer.

FIG. 5C schematically shows blade deposition.

FIG. 5D is an optical image of a blade deposited layer.

FIGS. 5E-G are SEM images of several blade-deposited porous metal oxide layers.

FIGS. 5H-J are XPS results comparing several different deposition configurations.

FIG. 5K shows optical spectroscopy results comparing two different substrate configurations.

FIGS. 6A-D are optical and SEM images of two spin-deposited porous metal oxide layers.

### DETAILED DESCRIPTION

Section A describes general principles relating to embodiments of the invention. Section B describes several detailed examples relating to this work.

### A) General Principles

An exemplary embodiment of the invention is a method of making a porous metal oxide layer, the method comprising:
depositing a solution onto a substrate to provide a deposited layer, wherein the solution includes a nonvolatile oxidizing reagent, a porogen, and one or more metal ion complexes of one or more metallic species;
aging the deposited layer to perform self-assembly in the deposited layer, wherein the structured, self-assembled layer is generated having a structure determined in part by the porogen; and
oxidizing the structured, self-assembled layer to form the porous metal oxide layer via a rapid, local, exothermic oxidation reaction that provides decomposition of the porogen.

Here pores of the porous metal oxide layer are formed by decomposition of the porogen in the oxidizing step, and the porous metal oxide layer has a pore structure corresponding to the structure of the structured self-assembled layer.

Optionally the structured, self-assembled layer can be dried at a temperature at or above ambient and below a metal oxidation ignition temperature to remove excess solvent, thereby providing a consolidated dried layer. Such drying can be performed for a duration between 10 minutes and 120 minutes. Some solvents can be sufficiently removed by aging at ambient temperature, while other solvents require a Separate drying step.

Preferably, decomposition of the porogen occurs after the film has consolidated during the oxidizing such that porosity is supported without pore collapse due to capillary forces.

The porogen can include a molecular species containing hydrophobic and hydrophilic constituents. In this case, the hydrophilic constituents of the porogen preferably include chemical units capable of interacting with cations of one or more metallic species.

The solution can include a metal oxidant salt acting as both a metal source and as the nonvolatile oxidant.

The solution can include an oxidant and a metal non-oxidant salt acting as the metal source for the oxide.

The solution can include one or more additional components such as: metal salts, polar hydrogen bonding solvents, dipolar aprotic solvents, polar chelating fuel species, and pH-regulating species. If present, the polar chelating fuel species can be included in sufficient concentration to perform one or more functions such as: stabilizing the solution, inhibiting premature hydrolysis, inhibiting hydroxide/oxide precipitation, and affecting the structure of the structured, self-assembled layer.

Practice of the invention does not depend critically on how the solution is deposited. Suitable deposition methods include, but are not limited to: ultrasonic spray deposition, blade coating, slot-die coating, spin coating, meniscus deposition, ink jet printing and gravure printing. Preferably, deposition is performed by moving a nozzle or the like over the substrate at a speed of 1 mm/s or more, and more preferably at a speed of 10 cm/s or more. As an example, the solution for ultrasonic deposition can be injected via syringe pump through an ultrasonic oscillating nozzle tip. The resulting droplets formed are deposited on the film as the nozzle moves across the substrate at speeds of approximately ≥1 mm/s (more preferably 10 cm/s or more).

The aging can be performed for a duration between 1 minute and 60 minutes.

Pores of the porous metal oxide layer can have pore sizes in a range from 0.1 nm to 100 nm.

The thickness of the metal oxide layer can be in a range from 10 nm to 5 μm.

Self-assembly can be performed in various ways, including but not limited to: evaporation induced self-assembly, solvent induced self-assembly, temperature induced self-assembly, surface induced self-assembly and electrochemically induced self-assembly.

Practice of the invention does not depend critically on the substrate. Suitable substrates include, but are not limited to: quartz, glass, UV and/or ozone treated glass, metals, metal oxides, polymers and polar surfaces. The substrate can be rigid or flexible.

The solution includes metallic species corresponding to the metal oxide to be grown (both for composition and doping), oxidants, a pore generating molecule, and an organic ligand fuel which can include the pore generating molecule. Subject to these conditions, practice of the invention does not depend critically on specific reagents or the like. In the following, several examples for each solution constituent are given

Suitable metallic elements for inclusion in the solution (e.g., as oxidant or non-oxidant metal salts) include, but are not limited to: Li, Na, Mg, Al, K, Ti, Co, Ni, Cu, Zn, Ga, Zr, Cd, In, Sn, Ba, La, Hf and Ta.

Suitable oxidants for inclusion in the solution include, but are not limited to: nitrates, chlorites, chlorates, perchlorates, hypochlorites, peroxydisulfates, peroxymonosulfates.

The metal ions can principally be derived from metal nitrates along with organic metal salts (i.e., citrates, lactates, acetylacetonates). Additionally, polar soluble materials such as metal chlorides, acetates, oxynitrates, fluorides, sulfates and organo-ligated complexes (i.e. oxalate, malonate, propoxide) can be utilized. When a non-nitrate metal ion source is used, subsequent nitrate oxidant sources can be introduced to the solution such as ammonium nitrate, organic amine nitrate salts, or quaternary ammonium nitrates (e.g. tetramethyl ammonium nitrate, etc.).

Suitable metallic non-oxidant salt species for inclusion in the solution include, but are not limited to: metal acetylacetonate salts, metal chlorides, metal acetates, metal oxynitrates, metal fluorides, metal sulfates, metallic organo-ligated complexes, metal oxalates, and metal alkoxides.

Suitable non-metallic oxidant salt species for inclusion in the solution include, but are not limited to: ammonium nitrate, organic amine nitrate salts, quaternary ammonium nitrates, tetramethyl ammonium nitrate, chlorites, chlorates, perchlorates, hypochlorites, peroxydisulfates, and peroxymonosulfates.

Suitable non-metallic non-salt oxidant species for inclusion in the solution include, but are not limited to: nitric acid, peroxydisulfuric acids, peroxymonosulfuric acids, peracids, aliphatic or aromatic organic nitro compounds, nitrobenzene, nitropropane, nitroethane, nitrous oxides, peroxide-containing organic species, peroxides, and hydroperoxides.

The pore generating molecule, herein called the porogen, preferably acts as a templating agent for the formation of porosity with variable size along with potential to act as a fuel in the combustion process.

Suitable porogens include di-and tri-block amphiphilic co-polymers as well as cationic, anionic, nonionic, and zwitterionic surfactants that form micelles including a hydrophilic and hydrophobic group. These hydrophilic groups can include but are not limited to: polyethylene oxide, polyamides, polyamines, polyamides, polyimines. These hydrophobic groups can include but are not limited to: polypropylene oxide, polystyrene, poly (methyl methacrylate), chitosan, aliphatic carbon chains, polylactides.

If present in the solution, the organic complexing fuel species preferably acts as a metal complexing ligand to assist in the ordering of the micelles into closed-packed structures, mitigate metal hydroxide formation in the solution and/or oxide premature condensation, and to promote solubility of metallic species in organic solvents. Ideally, the organic complexing fuel species should serve both as a metal complexing ligand to prevent volatilization and promote solubility in organic solvents and as a fuel for the oxidative combustion, where localized exothermicity drives the formation of the metal oxide films. Combustible ligands usually contain carbon and hydrogen, but may contain other elements as well which support or enhance the combustion process. To serve as a fuel, these materials should be combustible in the presence of an oxidizing agent such as nitrate ions, organic nitrates, nitrites, nitro derivatives. These examples are meant to be representative rather than comprehensive. Furthermore, solvent/fuel combinations such as oxidizing/oxidizable species like nitrobenzene, nitropropane, and nitroethane can be considered as possible oxidizing/fuel sources that also solubilize the metal salts.

Suitable complexing compounds for inclusion in the solution include, but are not limited to: alcohols, ketones, aldehydes, carboxylic acids, esters, ethers, oximes, hydroxamic acids, diols, polyols, polyfunctional ethers, dimethoxyethane, polyethylene glycols, alpha and beta hydroxy aldehydes, beta diketones, beta keto esters, beta keto acids, and oxylates.

Suitable oxidizing species for inclusion in the solution include, but are not limited to: aromatic organic nitro compounds, aliphatic organic nitro compounds, nitroacetylacetone, nitro carboxylic acids, organic peroxides, organic hydroperoxides, and organic peracids. Oxygen for the thin-film metal oxide can comes in part from oxidizing species that are part of the organic complexing fuel species.

### B) Detailed Examples

The following results describe the various aspects of the chemistry, processing and structure of the developed approach to produce structured, mesoporous, aluminum oxide thin films rapidly at processing temperatures as low as 200° C. Critical aspects including the solution chemistry, and control over the self-assembly of the deposited precursor that enables the low processing temperatures and rapid processing times are presented and discussed. Finally, the compatibility of the process with scalable manufacturing techniques such as doctor blading, ultrasonic spray deposition and near-infrared (NIR) flash annealing is considered. The following description is by way of example, and is not to be construed as limiting any aspect of embodiments of the invention to any of the specifics of these examples.

### B1) Chemistry and Combustion in Bulk and in Thin Film

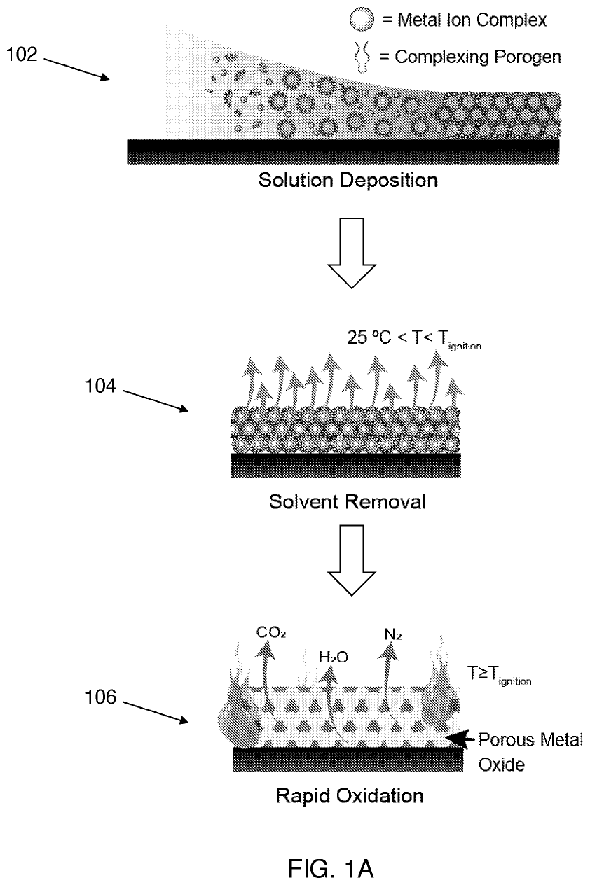

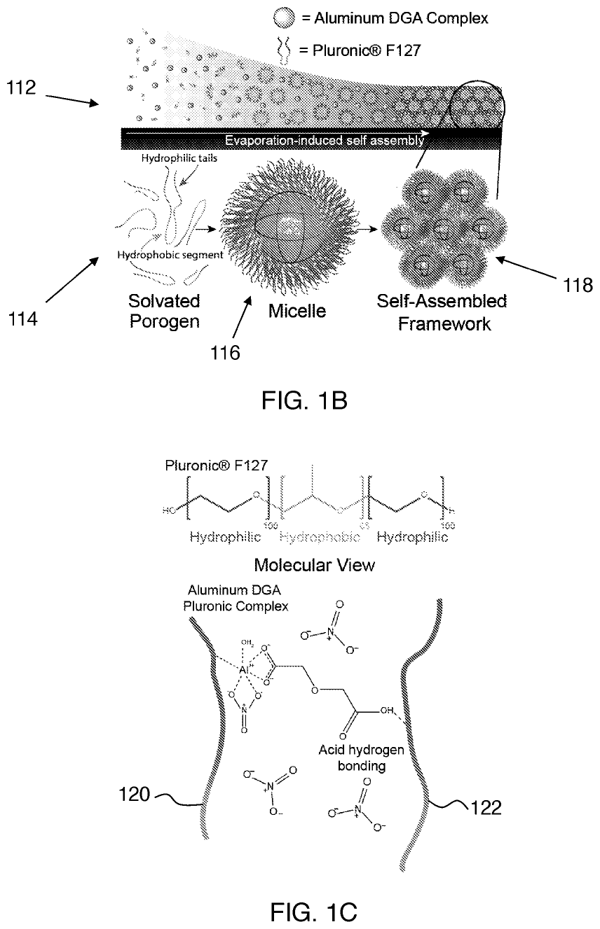

FIGS. 1A-C show aspects of the synthesis approach considered herein. FIG. 1A is an overview of film deposition 102 (including formation processes showing the formation and self-assembly of polymeric micelles), the removal 104 of the deposition solvent, and the redox reaction 106 that simultaneously converts the Aluminum complex to the oxide and burns out the polymer structuring agent. FIG. 1B is a detail showing the self-assembly 112 of the Pluronic@ F127 tri-block co-polymer 114 into the micellar framework 118 including micelles 116. FIG. 1C is a detail showing the proposed bonding environment for the Aluminum complexes involving the nitrate anions, diglycolic acid, and ether oxygens of the PEO (poly (ethylene oxide) ) segments 120, 122 in the Pluronic® F127.

We have termed our approach as porogen-integrated rapid oxidation, or PIRO. An overview of the approach is detailed in FIGS. 1A-C. PIRO involves a precursor solution containing: a metal nitrate salt, an organic ligand, and a micelle forming block co-polymer.

At a high level, (FIG. 1A) the process of the film involves three steps, first the precursor solution is deposited by an appropriate deposition technique, then the film is dried (or aged) to remove the solvent, and finally the film is cured through a rapid oxidation process by raising the temperature of the film to the ignition temperature.

The deposition and self-assembly (FIG. 1B) of the amphiphilic block co-polymers into a lattice of ordered micelles has previously been extensively described. The metal cation complexes segregate into the hydrophilic corona to form a lattice structure at room temperature in standard atmospheric conditions.

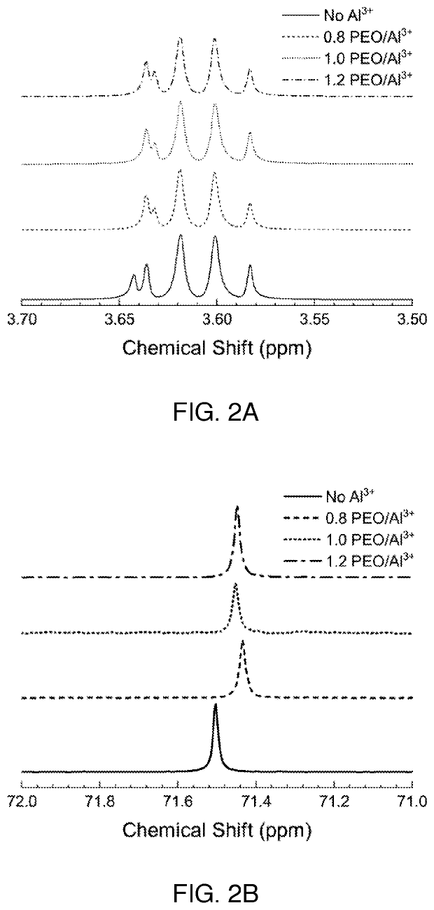

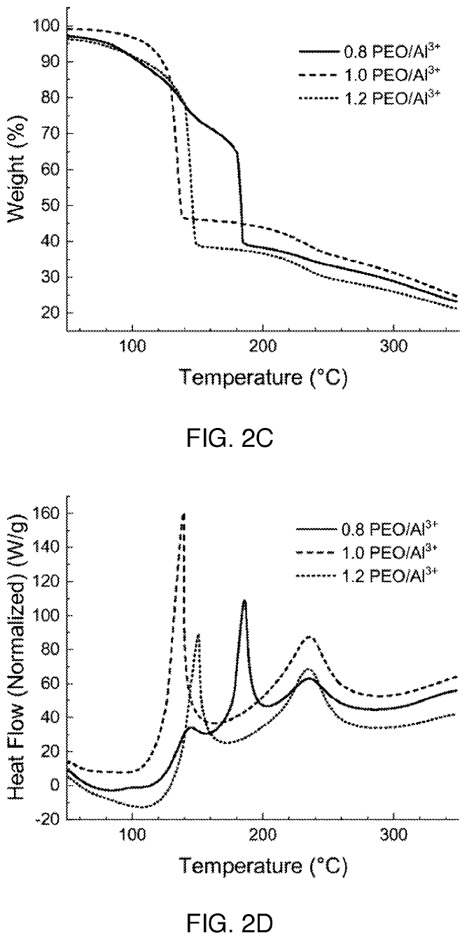

FIG. 2A is a ¹H NMR of the F127. Solutions containing Al(NO₃)₃ show a downshift of the PEO-block F127 protons relative to the protons of the PEO in F127 in ethanol without Al(NO₃)₃. FIG. 2B is a ¹³C NMR of the ether carbon of the PEO unit in the Pluronic® F127. Addition of Al(NO₃)₃ results in a downshift of the ether carbon. For NMR measurements, solutions not containing Al(NO₃)₃ are adjusted with dilute HNO₃ to an equivalent pH and water content. FIG. 2C shows TGA (thermogravimetric analysis) and FIG. 2D shows DSC (differential scanning calorimetry) of dried precursor powders with different amounts of F127, both figures showing the sudden mass loss and strongly exothermic peak between 120° C. and 200° C.

The precursor solution can be reacted under heating to encourage the coordination of the metal cation to the PEO-block of the polymer. (FIG. 1C) For the case outlined in this second utilizing Al(NO₃)₃·9H₂O, the Al³⁺ cation will coordinate to the ether oxygens comprising the PEO block after an appropriate rection time (FIGS. 2A-B). Coordination of the Al³⁺ to the PEO acts to slow undesirable hydrolysis reactions in solution and, when deposited, allows for self-assembly of the polymer-complex system to occur. An additional organic ligand can also be included in the precursor solution to tune the self-assembly and aid the formation of a specific space group. The impact of organic ligands on the self-assembly of the mesoporous structure will be examined further below.

¹H (FIGS. 2A) and ¹³C (FIG. 2B) NMR of Al(NO₃)₃·9H₂O and Pluronic® F127 in an Ethanol/Methanol-d4 mixture show a distinct downshift in the peak position for the ether carbon of the Pluronic® F127 when Al(NO₃)₃·9H₂O is included in the solution relative to a control solution. The control solution does not include Al(NO₃)₃·9H₂O, but is adjusted with dilute HNO₃ to an equivalent pH and H₂O content. The downshift suggests a less electronegative environment for the PEO, consistent with the proximity of the highly charged Al³⁺ cation to the PEO segments. Decreasing the molar concentration of the Pluronic@ relative to the Al³⁺ results in a small additional downshift of the PEO peak position as a larger fraction of the PEO in solution is ligating Al³⁺.

Combined TGA (FIG. 2C) and DSC (FIG. 2D) of powders dried from solutions shows an increase in the combustion temperature from 139° C. to 150.6° C. as well as a decrease in the enthalpy of the combustion from 10.1 KJ/g to 6.3 KJ/g as the molar ratio of PEO to Al³⁺ is increased from 1 to 1.2.

Modifying the molar concentration of PEO relative to aluminum nitrate directly influences the combustion fuel/oxidant ratio and can yield fuel rich conditions with excess PEO, fuel lean conditions with excess nitrate, or fuel balanced conditions with equal quantity of PEO and nitrate available for participation in combustion. Increased PEO content in the 1.2 molar ratio sample shows a reduced overall combustion heat flow and suppressed reaction temperature.

Additionally, the second exothermic peak associated with the decomposition of the carbonaceous residues shows increased intensity relative to the main combustion peak in the 1.2 molar ratio specimen versus the 1 molar ratio combustion. This increased influence of the second peak is demonstrative of a fuel-rich configuration.

In contrast, reducing the PEO block concentration by decreasing the PEO molar ratio from 1 and 0.8 suggests a fuel lean situation. For the 0.8 molar ratio of PEO to Al³⁺, there are three exothermic peaks; one peak indicates the degradation of the precursor before combustion can occur followed by the combustion event and subsequent degradation of the carbonaceous residues. The third carbon residue degradation peak is much smaller in relative exothermicity in the 0.8 molar ratio specimen compared with the 1 molar ratio sample owing to the reduced PEO in the reaction yielding less combustible carbon.

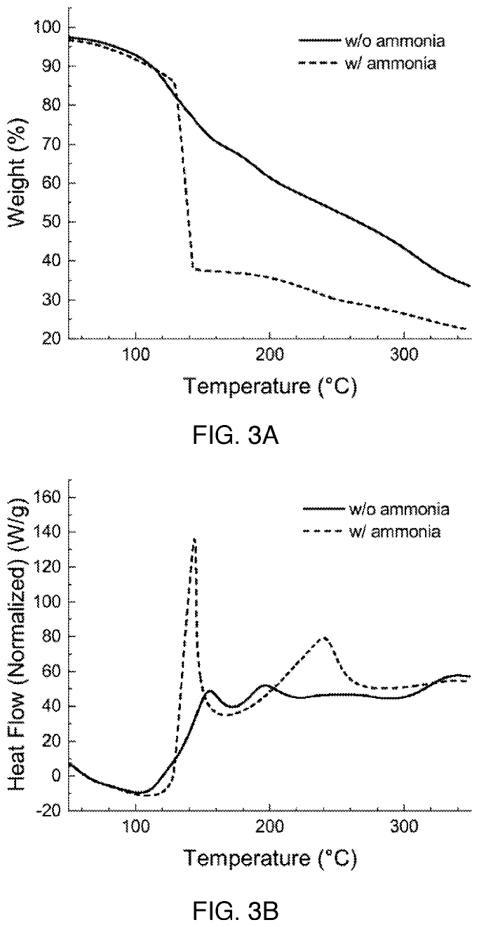

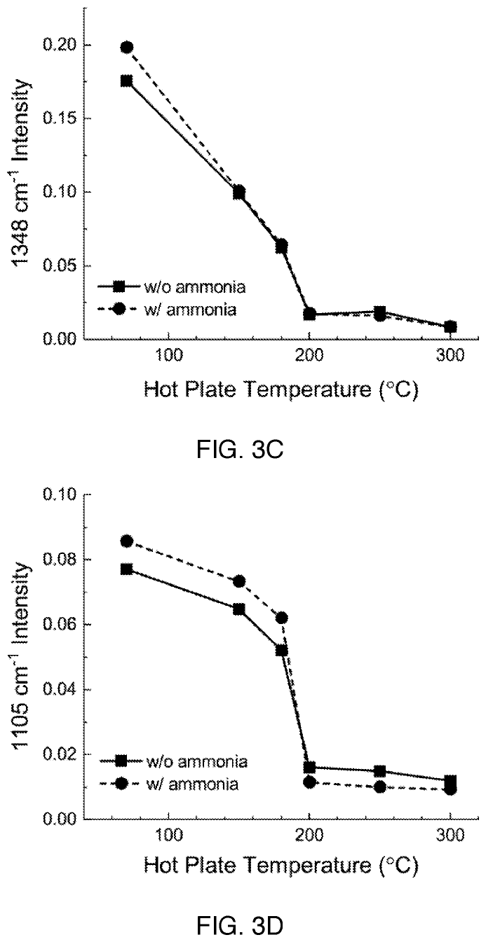

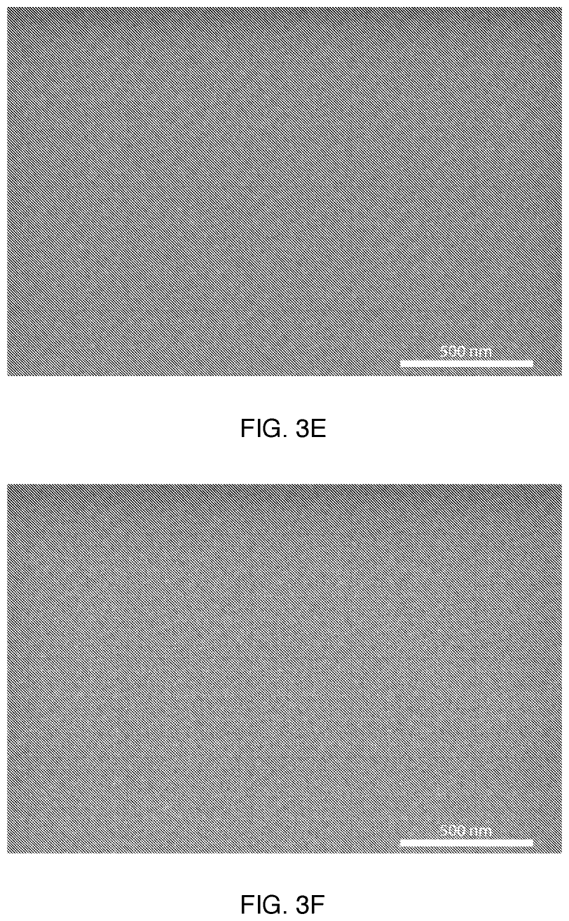

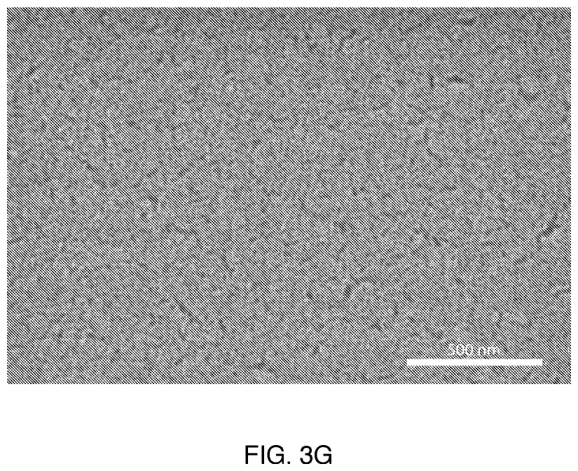

FIG. 3A shows TGA and FIG. 3B shows DSC of the precursor with and without ammonia showing no rapid combustion event and corresponding exotherm in precursor with ammonia. FIG. 3C shows absorbance of the NO₃ at 1348 cm⁻¹ from the aluminum nitrate with increasing cure temperature. FIG. 3D shows absorbance of the C—O stretch at 1105 cm⁻¹ in Pluronico F127 with increasing cure temperature. FIGS. 3E and 3F are SEM images showing highly ordered pore surface structures with 0 and 0.28 molar ratio of ammonia to Al³⁺, respectively, and the result of FIG. 3G at 0.56 molar ratio of ammonia to Al³⁺ shows disordered surface porosity.

The addition of ammonia to solution combustion reaction precursors has previously been shown to improve combustion efficiency, although this has been explained as an increase in pH driving the deprotonation and subsequent co-ordination of carboxylic acid or acetylacetonate fuels. The reaction of the same precursor compositions is studied for the thin film PIRO. As the mass of the thin film is too small for standard TGA and DSC techniques the reaction is investigated ex situ through FTIR spectroscopy of the films after curing for 1 min at increasing hotplate temperatures for precursors without FIG. 3A) and with FIG. 3B) ammonia added.

IR spectroscopy of the dried, but unreacted, film shows split peaks at 1430 cm⁻¹ and 1348 cm⁻¹ which is assigned to the degenerate v₃ mode of the nitrate coordinated to the Al³⁺.

Previous studies have demonstrated that the splitting of the v₃ mode is associated with coordinated nitrate. The other prominent peak of interest is the stretch mode of the C—O—C group at 1105 cm1 associated with PEO in the Pluronic® F127.

At a set hotplate temperature of 200° C. a sudden loss is observed in C—O—C (FIG. 3C) consistent with sudden oxidation of the Pluronic@ within the thin film. The loss of the Pluronic® at 200° C. is lower than what is observed in TGA for Pluronic® F127. Tracking the intensity of the nitrate absorption at 1348 cm-1 shows a gradual loss of nitrate with increasing cure temperature up until 200° C. (FIG. 3D). Al(NO₃)₃·9H₂O is known to degrade at elevated temperatures, and so a loss of nitrate species in the reacted film is not surprising, but highlights that a successful combustion reaction requires a rapid increase in temperature to the ignition temperature to prevent precursor degradation.

### B2) Structural Analysis of Films With Ligands of Increasing Acidity

Films made from just Pluronic@ F127 and aluminum nitrate are not fully ordered through the thickness of the film. SEM and ellipsometry analysis suggest an ~80 nm thick ordered layer with on the top surface and the remaining film is a randomly distributed network of spherical pores.

Investigations conducted into each aspect of the precursor solution and deposition process showed that the film structure was relatively insensitive to changes in H₂O content, time spent at room temperature before drying, among other variables. As a result, it is anticipated that the incomplete ordering is a thermodynamic limitation and not a kinetic limitation.

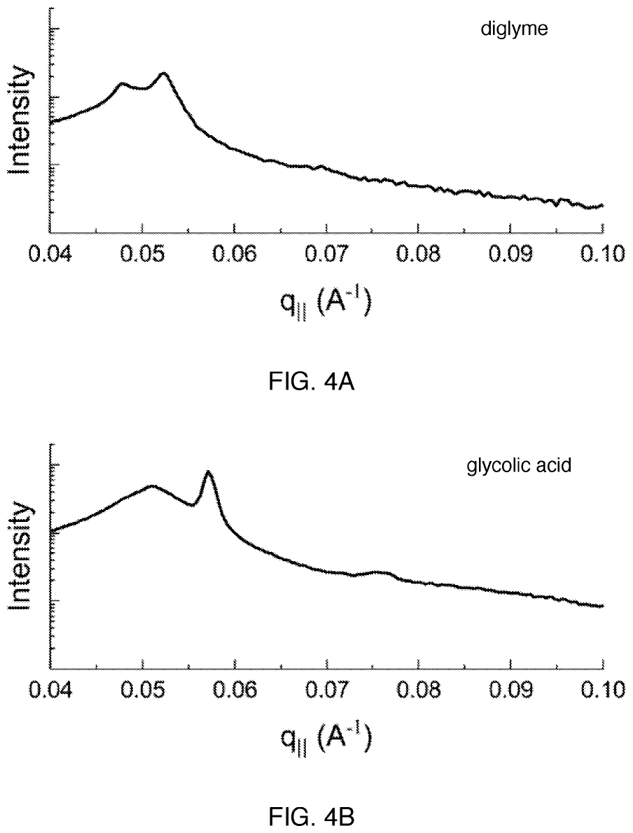

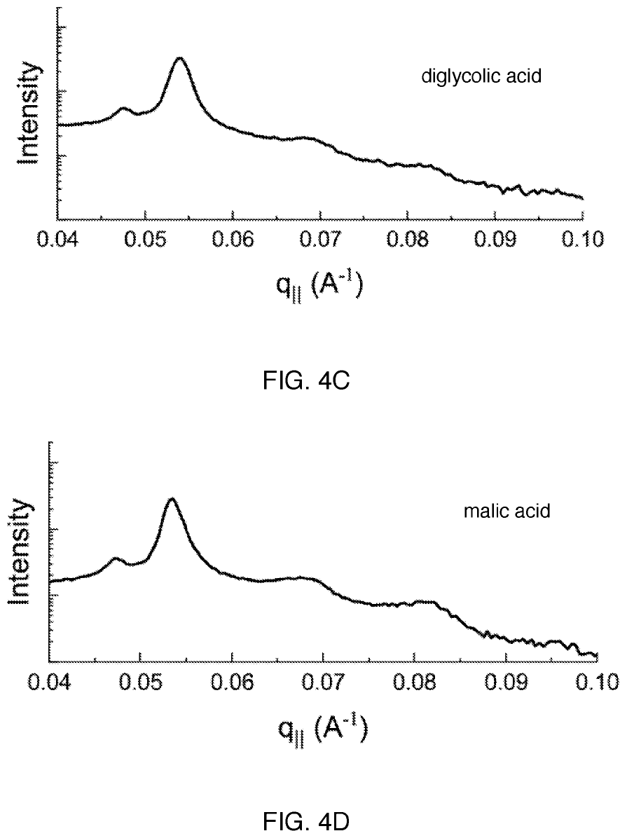

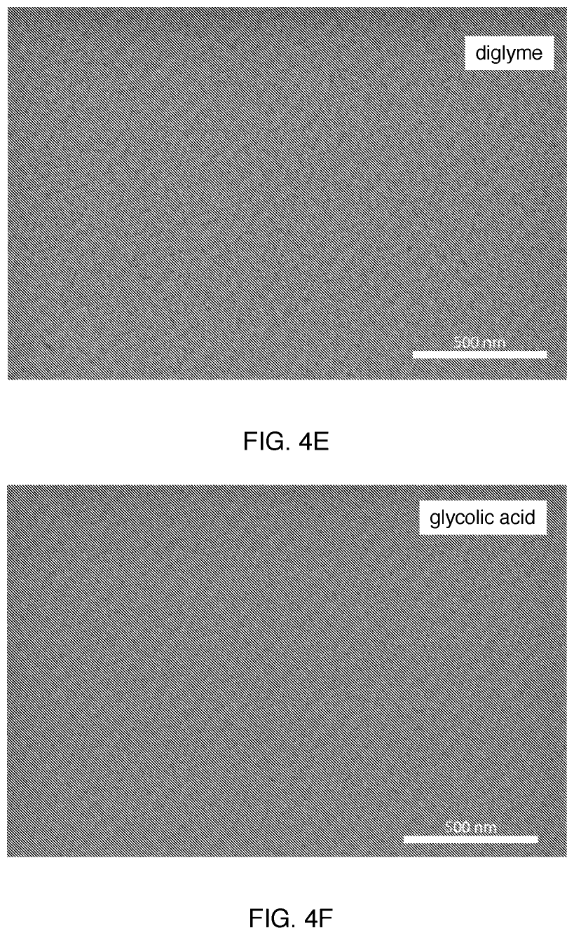

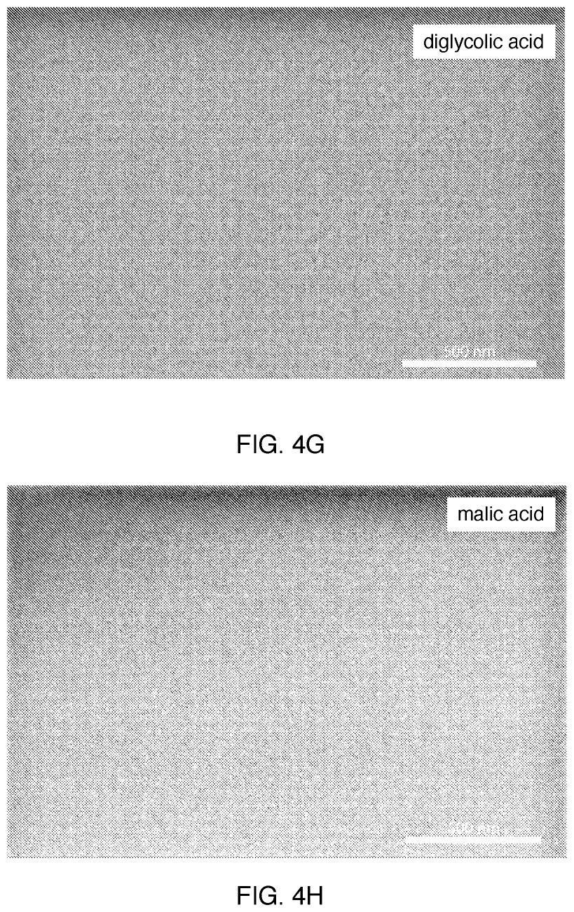

FIGS. 4A, 4B, 4C, 4D show grazing incidence small angle X-ray scattering (GISAXS) of thin films generated with diglyme, glycolic acid, diglycolic acid, and malic acid, respectively, showing differences in the degree of ordering in the bulk of the film based on the presence of more acidic hydrogen bonding moieties in the small molecule organic ligand. FIGS. 4E, 4F, 4G, 4H are SEM images of the surfaces of films generated with diglyme, glycolic acid, diglycolic acid, and malic acid showing comparable surface ordering.

To investigate the inclusion of additional small-molecule organic ligands and their impact on film structure, GISAXS and SEM were used to study ligands with and without carboxylic acid moieties. Diglyme, (FIGS. 4A, 4E) Glycolic acid, (FIGS. 4B, 4F) Diglycolic acid, (FIGS. 4C, 4G) and Malic acid (FIGS. 4D, 4H) were added to precursor solutions before deposition and curing. All ligands were added in equivalent molar amounts except for glycolic acid for which double the molar amount was added. This was so that the glycolic acid, diglycolic acid, and malic acid had equivalent molar amounts of carboxylic acid moieties.

The transition from a mixed film with random porosity and ordered porosity to a film with completely ordered porosity can be explained based on the strength of the hydrogen bonding between the Al³⁺ complexes and the PEO. Previous models of the self-assembly of silica sols with amphiphilic surfactants such Pluronic® highlight the hydrogen bonding between the acidic silanol groups and the ether oxygen of the PEO. Silanol groups are uniquely acidic among common metal hydroxides. Introducing carboxylic acid ligands improves the hydrogen bonding strength between the Al³⁺ complexes and the Pluronic@ and encourages the formation of ordered mesoporous thin films comprising a single space group.

Comparison between films made with glycolic acid and diglycolic acid demonstrate that a ligand must be able to coordinate the Al³⁺ cation and have a free carboxylic acid group for hydrogen bonding. (FIG. 1C)

Glycolic acid, which is a ligand with a single carbonyl group, is not effective for producing an ordered structure. Diglycolic acid however, can coordinate to Al³⁺ through one of the carboxylic acid groups and the ether oxygen, leaving a free carboxylic acid group for hydrogen bonding. Malic acid similarly results in an ordered film structure; however, film morphology suffers from the ability of malic acid to form complexes with reduced solubility in ethanol. These low-solubility, larger metal ligand complexes result in substantial film defects that are not observed in the ordered films formed with diglycolic acid.

Finally, the pKa of glycolic acid, diglycolic acid, and malic acid are all relatively comparable and similar to the native pH of the Al(NO₃)₃·9H₂O in ethanol, suggesting that changes in the structure can't be the result of changes in pH.

### B3) Large-Area Manufacturing Capability

A limiting factor for many previous approaches to manufacturing large-area metal oxide thin films is their incompatibility with roll-to-roll processing techniques and flexible substrates due to their environmental sensitivity, aggressive formulations, and the extended curing and sintering steps at high temperatures required. Here, we demonstrate the PIRO deposition and curing steps with roll-to-roll compatible processing techniques.

For deposition, both blade coating and ultrasonic spray deposition were tested. Blade coating, a technique used ubiquitously in thin film manufacturing especially for energy storage and batteries, uses a steel blade coated with nonpolar Teflon to generate a meniscus between the solution and the substrate and gradually deposit high quality films. Ultrasonic spray coating uses a vibrating nozzle at 2 W and 120 kHz to aerosolize droplets of the precursor into a mist that can be quickly deposited into conformal coatings.

The deposited films can then be cured by various scalable curing techniques including via near infrared (NIR) flash curing. NIR curing lamps leverage tungsten emitters to generate a black body radiation profile with peak emission at approximately 900 nm. The Adphos system generates intense infrared along with high wavelength visible light. The NIR system was tested on strong IR absorbing substrates (Si and aluminized PI), and less IR absorbing (fused silica) . Aluminum coatings were used on the polymer substrates for multiple reasons: metals strongly absorb infrared radiation allowing for rapid and efficient conversion of light to heat, the aluminum surface is highly polar and complementary to our solution chemistry, and metal thin films can act as electrodes when integrating these mesoporous oxides into functional electronic devices.

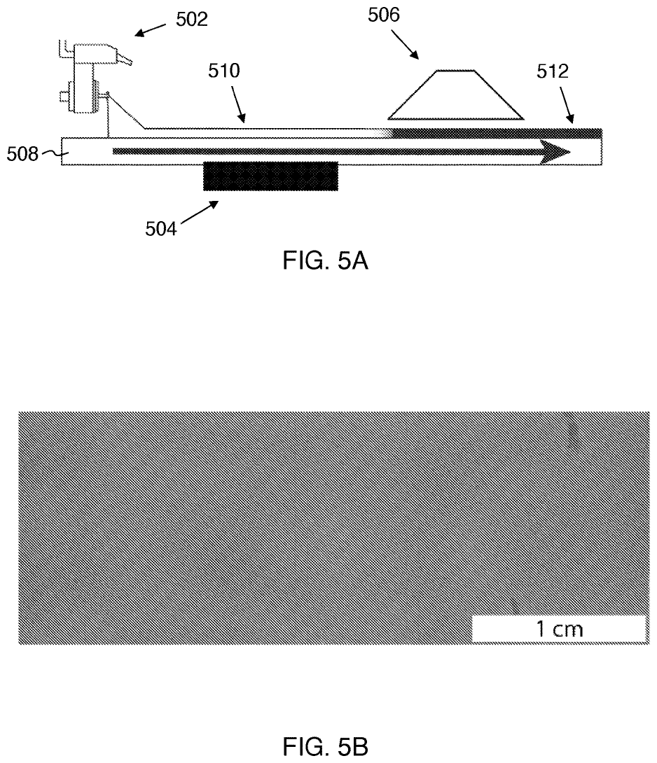

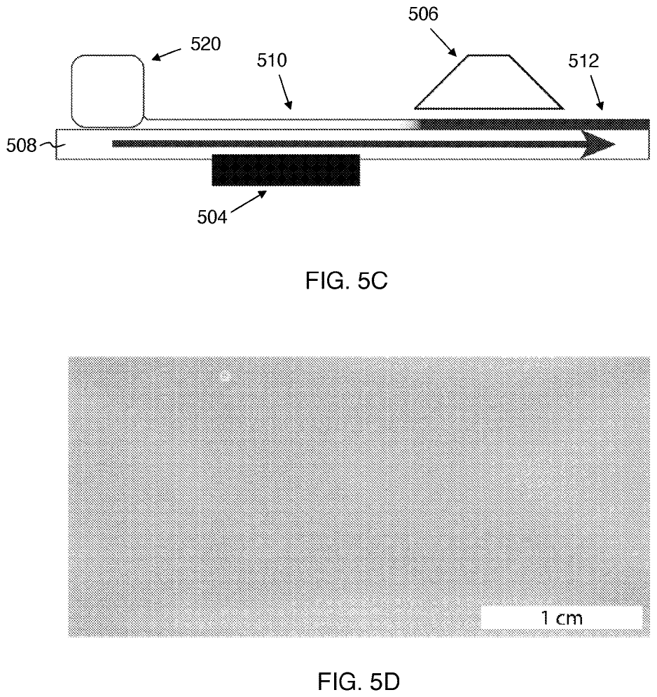

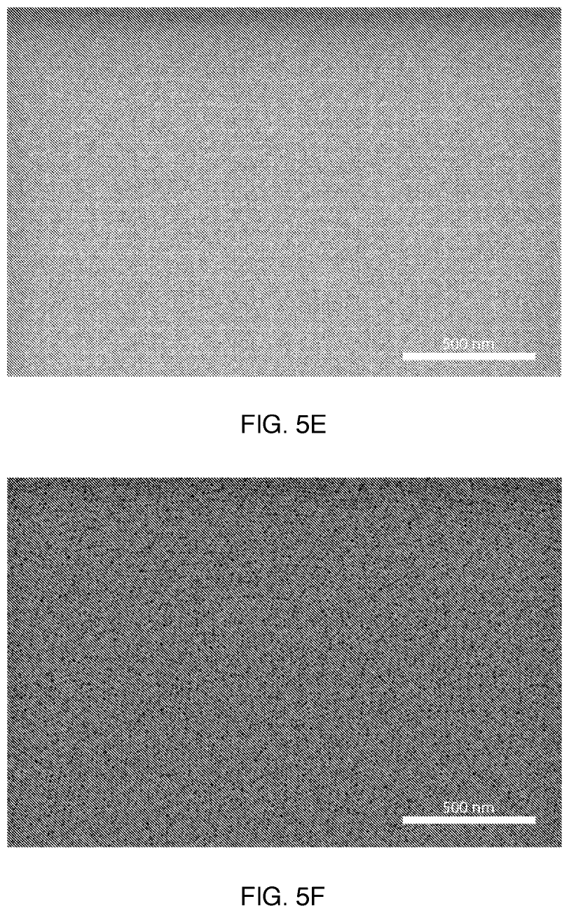

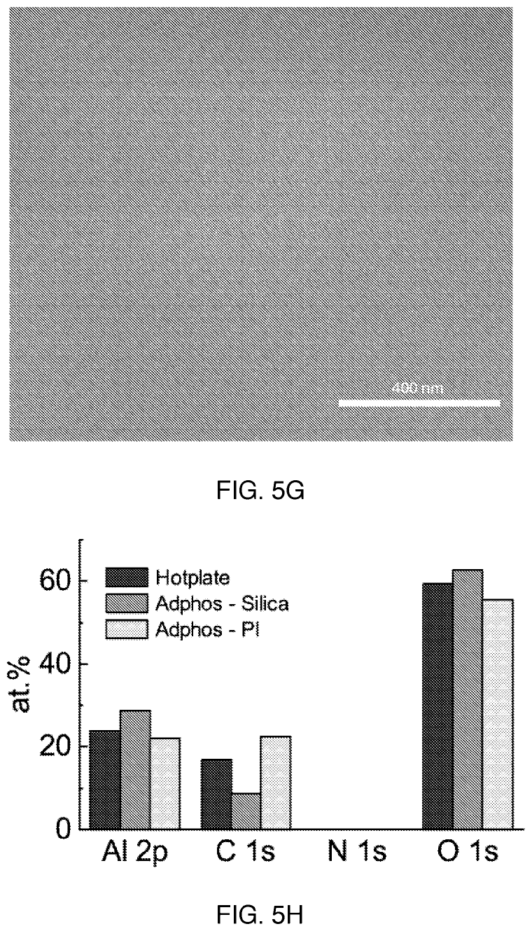

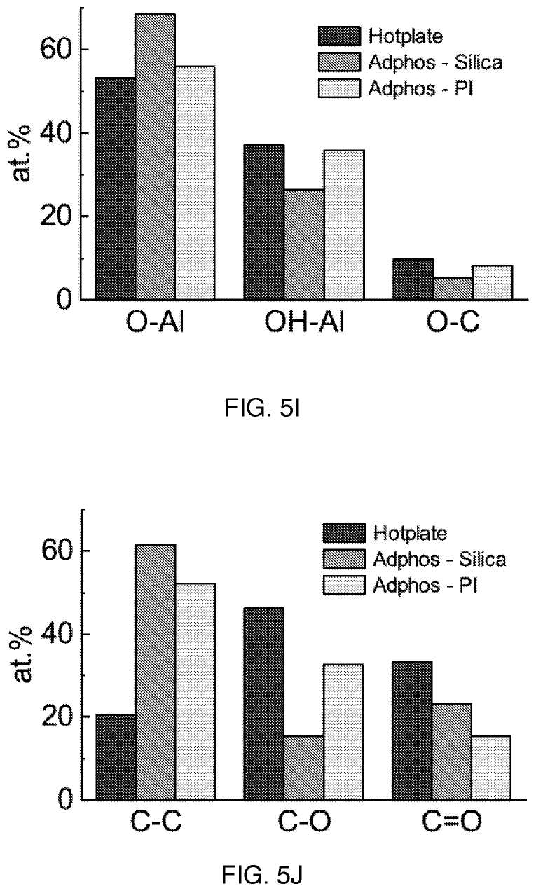

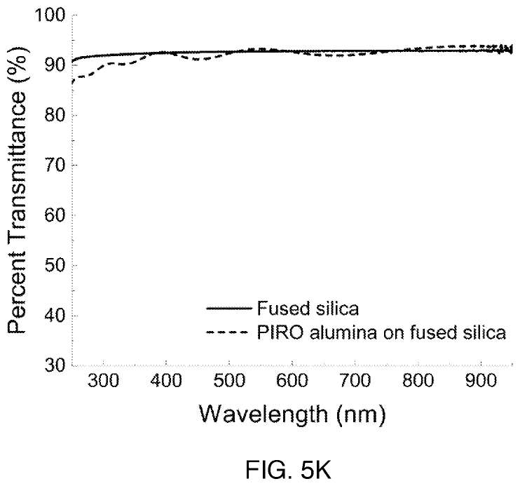

FIG. 5A is a schematic of the preferred embodiment generating films via ultrasonic spray followed by near-infrared flash annealing. Here 502 is the spray nozzle for deposition, 504 is an optional heater, 506 is the flash annealing unit, 508 is the substrate, 510 is the deposited solution and 512 is the porous metal oxide. Relative motion is as indicated by the arrow, substrate 508 moving to the right with respect to nozzle 502 and annealer 506. FIG. 5B is an optical image of a porous metal oxide film generated by ultrasonic spray. FIG. 5C is a schematic of the preferred embodiment generating films via blade coating followed by near-infrared flash annealing. Here 520 is the doctor blade deposition unit and the other components are as indicated above. FIG. 5D is an optical image of a film generated by blade coating.

FIG. 5E is an SEM image of a film doctor bladed onto silicon and hot plate cured. FIG. 5F is an SEM image of a film doctor bladed onto silicon and cured via a NIR flash anneal.

FIG. 5G is an SEM image of a film doctor bladed onto aluminized PI (polyimide) and cured via a NIR flash anneal.

FIG. 5H shows XPS (x-ray photoelectron spectroscopy) results of thin films generated on silicon wafer with hotplate curing, fused silica with near-infrared curing, polyimide with 50 nm aluminum metal showing Al 2p, C 1s, N 1s, O 1s. FIG. 5I is high-resolution analysis of 1s oxygen bonding in the results of FIG. 5H. FIG. 5J is high-resolution analysis of carbon 1s bonding in the results of FIG. 5H. FIG. 5K shows UV/Vis spectroscopy of blade coated and near-infrared cured porous alumina on fused silica substrate.

Examples of the proposed inline processing steps are shown for ultrasonic spray deposition (FIGS. 5A-B) and blade coating (FIGS. 5C-D). Examples of the PIRO films after curing are shown in FIGS. 5E, 5F, 5G for blade coating. These films exhibit large area uniformity and suggest PIRO is a promising candidate for deposition of the porous films at scale.

To investigate the efficacy of the NIR curing, XPS was conducted to examine the elemental composition (FIGS. 5H), O 1s peak components (FIG. 5I), and C 1s peak components (FIG. 5J) of films cured via NIR on fused silica and polyimide (PI) substrates.

Films cured with NIR in just one minute at a 1-2 cm working distance show either improved or comparable curing than films cured on the hotplate, with NIR cured films on Silica demonstrating a lower carbon content and a higher atomic concentration of Al—O bonds based on the O 1s peak analysis. Additional SEM on hotplate and NIR cured films deposited by blade coating show that both the hotplate cured (FIG. 5E) and NIR cured films (FIG. 5F) demonstrate well defined, ordered pore structure. Similarly, PIRO films were successfully deposited and cured on PI metallized with 50 nm of aluminum. (FIGS. 5G, 5K) The compatibility of the PIRO reaction with flexible substrates opens a wide range of possible applications.

UV-Vis spectroscopy of the PIRO films (FIG. 5K) demonstrates the excellent optical clarity with less than 1% transmission loss in the visible spectrum compared to a blank fused silica substrate.

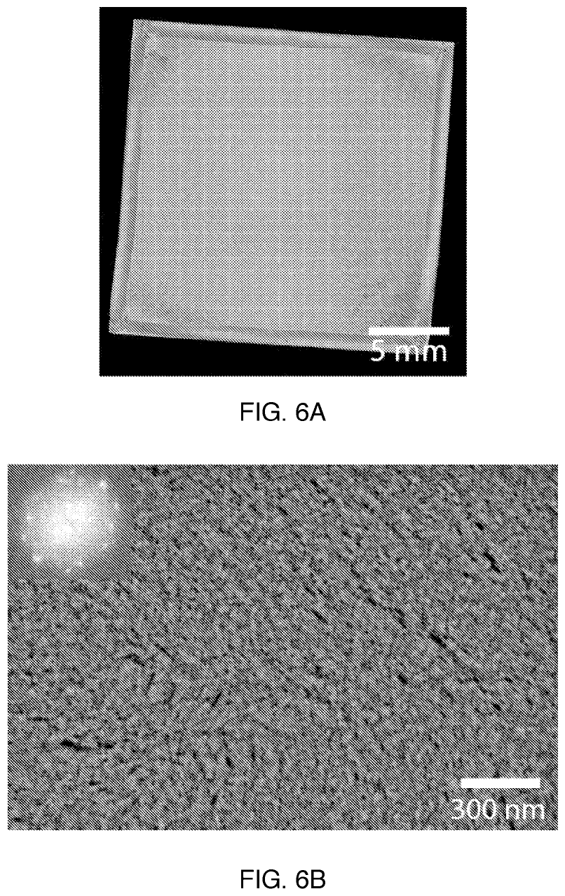

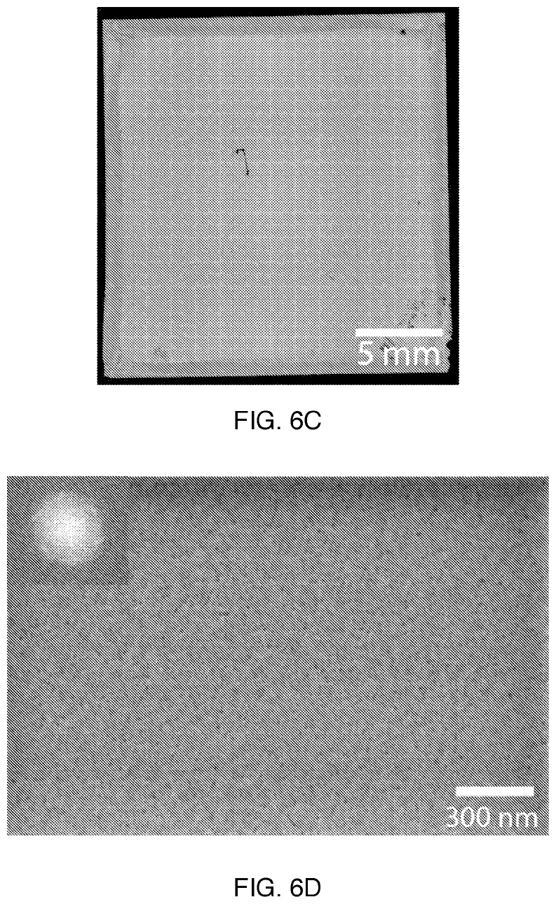

FIG. 6A is an optical image of a spin coated thin film of porous nickel oxide. FIG. 3B is a corresponding SEM image with fast Fourier transform (inset) of porous nickel oxide showing surface ordering.

FIG. 6C is an optical image of a spin coated thin film of porous zinc oxide. FIG. 6D is a corresponding SEM image with fast Fourier transform (inset) of porous zinc oxide.

### B4) Conclusions

An approach we have termed PIRO (porogen integrated rapid oxidation) utilizes solution combustion synthesis along with micelle-forming block co-polymers to successfully deposit and cure films of Aluminum Oxide with structured porosity up to 500 mm thick. The success of PIRO is the result of the coordination chemistry between the aluminum cation and the chelating properties of the hydrophilic polyethylene oxide segment of the polymer inhibiting premature hydrolysis and enabling the rapid oxidation of the polymer. Further the inclusion of an additional organic ligand can act as a structuring agent, allowing repeatable and controllable tuning of the pore structure. We also demonstrate the scalable manufacturing of alumina via PIRO on a variety of substrates at linear processing speeds of up to 6 m/min and with a 1 minute cure time using NIR flash annealing. The result is an over 95% reduction in processing time relative to conventional sol-gel processes from days to less than 1.5 hours. In summary, this study outlines the complete process for the scalable deposition of highly uniform, structured mesoporous aluminum oxide thin films. With modification of the choice of structuring ligands and polymer, we anticipate being able to extend PIRO to a range of transition metal, rare earth and mixed metal oxides to rapidly expand the library of structured, mesoporous, metal oxides that can be deposited quickly and at scale. We anticipate the PIRO will enable uptake of these films in a wide range of applications including optoelectronics, thin film catalysis, and energy storage.

### B5) Methods

### Materials

Aluminum nitrate nonahydrate (98%+, ACS grade), Pluronic® F127, aqueous ammonium hydroxide (30-33%, puriss.), anhydrous ethanol (absolute, 200 proof), diglyme, diglycolic acid, malic acid, and citric acid were purchased from Sigma Aldrich and were used as received. Acetone (HPLC grade) and IPA (HPLC grade) were purchased from Fisher Scientific and used as received.

For conventional deposition, single-sided polished silicon wafer and soda-lime glass were cleaned by first scrubbing with 1% Alconox solution and rinsed in DI water. Substrates were then ultrasonicated in acetone for 10 min, followed by ultrasonication in IPA for another 10 min. Finally, substrates were then treated under UV/Ozone for 15 min and used immediately.

### Synthesis

To prepare solutions for PIRO, aluminum nitrate nonahydrate was dissolved into absolute anhydrous ethanol. Pluronic® F127 was then added to the aluminum nitrate sock and allowed to dissolve under stirring. Next, ammonia was diluted in ethanol and slowly added dripwise under strong stirring to the solution containing the aluminum nitrate and Pluronic® F127. Small white wisps will form in the solution and should immediately redissolve during base addition. The solution was then allowed to react under gentle stirring overnight at 60° C. in a sand bath. After overnight heating, the solution is pale yellow. The appropriate complexing co-fuel small molecule (e.g., diglyme, diglycolic acid, etc.) is then added and the solution is allowed to stir for another 2 hours at 60° C. Solutions are observed to be shelf stable.

For conventional deposition and curing, films were spin coated at 2000 rpm with a 500 rpm/sec acceleration for 20s onto silicon or soda-lime glass substrates. Following spin coating, films were left at ambient conditions for 15 min for self-assembly to occur and then transferred to an oven at 70° C. to dry for up to 1 hr. The films were then combusted by placing the dried films onto a preheated Wenesco high uniformity hotplate at 230° C. for up to 30 minutes. The combustion process is generally accompanied by a puff of white smoke and a rapid change in index of refraction observable as a rapid color change in the oxidized films. After curing, the films are stored in an air-free glove box or under vacuum desiccation until characterization.

Blade coating was performed using an MSI four-sided stainless-steel blade coater using an automatic, programmable gantry system. The substrate was placed on a smooth glass substrate. Solution was deposited to pre-form the meniscus at the leading edge of the substrate and then the blade moved across the substrate at a variable programmed speed up to 1 cm/sec.

Ultrasonic spray was also used as a scalable technique to form self-assembled films. The stock solution described above was diluted 10 times in absolute anhydrous ethanol and sprayed at up to 6 m/min with a single pass speed over the substrate from a SonoTek Impact nozzle and with a nitrogen shaping gas flow.

Films from both blade and spray coating were then allowed to self-assemble for 15 minutes followed by 1 hour of drying in a 70° C. oven. A longer drying step for these larger area, thicker films was found to be preferable for ensuring proper combustion and subsequent morphology.

An Adphos near-IR curing system was also employed to initiate combustion in the thin films. Curing as performed using an Adphos NIR 50-50 with two tungsten emitters at 1 cm height from the substrate for 1 minute at 100% power. The substrates were air-gapped to isolate heating from the NIR emitters to the absorbance from the solution and substrate.

1. A method of making a porous metal oxide layer, the method comprising:
depositing a solution onto a substrate to provide a deposited layer, wherein the solution includes a nonvolatile oxidizing reagent, a porogen, and one or more metal ion complexes of one or more metallic species;
aging the deposited layer to perform self-assembly in the deposited layer, wherein the structured, self-assembled layer is generated having a structure determined in part by the porogen;
oxidizing the structured, self-assembled layer to form the porous metal oxide layer via a rapid, local, exothermic oxidation reaction that provides decomposition of the porogen;
wherein pores of the porous metal oxide layer are formed by decomposition of the porogen in the oxidizing step, wherein the porous metal oxide layer has a pore structure corresponding to the structure of the structured self-assembled layer.

2. The method of claim 1, further comprising drying the structured, self-assembled layer at a temperature at or above ambient and below a metal oxidation ignition temperature to remove excess solvent, thereby providing a consolidated dried layer.

3. The method of claim 2, wherein the drying the structured, self-assembled layer is performed for a duration between 10 minutes and 120 minutes.

4. The method of claim 1, wherein decomposition of the porogen occurs after the film has consolidated during the oxidizing such that porosity is supported without pore collapse due to capillary forces.

5. The method of claim 1, wherein the porogen includes a molecular species containing hydrophobic and hydrophilic constituents.

6. The method of claim 5, wherein the hydrophilic constituents of the porogen include chemical units capable of interacting with cations of the one or more metallic species.

7. The method of claim 1, wherein the solution includes a metal oxidant salt acting as both a metal source and as the nonvolatile oxidant.

8. The method of claim 1, wherein the solution includes an oxidant, and a metal non-oxidant salt acting as the metal source for the oxide.

9. The method of claim 1, wherein the solution includes one or more additional components selected from the group consisting of: metal salts, polar hydrogen bonding solvents, dipolar aprotic solvents, polar chelating fuel species, and pH-regulating species.

10. The method of claim 9, wherein the polar chelating fuel species is included in sufficient concentration to perform one or more functions selected from the group consisting of: stabilizing the solution, inhibiting premature hydrolysis, inhibiting hydroxide/oxide precipitation, and affecting the structure of the structured, self-assembled layer.

11. The method of claim 1, wherein deposition of the solution on the substrate is performed according to a method selected from the group consisting of: ultrasonic spray deposition, blade coating, slot-die coating, spin coating, meniscus deposition, ink jet printing and gravure printing.

12. The method of claim 1, wherein the aging is performed for a duration between 1 minute and 60 minutes.

13. The method of claim 1, wherein pores of the porous metal oxide layer have pore sizes in a range from 0.1 nm to 100 nm.

14. The method of claim 1, wherein a thickness of the metal oxide layer is in a range from 10 nm to 5 μm.

15. The method of claim 1, wherein the self-assembly is selected from the group consisting of: evaporation induced self-assembly, solvent induced self-assembly, temperature induced self-assembly, surface induced self-assembly and electrochemically induced self-assembly.
